(19) United States
(12) Patent Application Publication
(10) Pub. No.: US 2024/0174568 A1
(43) Pub. Date: May 30, 2024

(54) CEMENTITIOUS COMPOSITION

(71) Applicant: BASF SE, Ludwigshafen am Rhein (DE)

(72) Inventors: Harald GRASSL, Trostberg (DE); Joachim DENGLER, Trostberg (DE); Marita SPIERLING, Trostberg (DE)

(21) Appl. No.: 18/279,952

(22) PCT Filed: Feb. 14, 2022
(86) PCT No.: PCT/EP2022/053481

§ 371 Date: Sep. 1, 2023

(30) Foreign Application Priority Data
Mar. 5, 2021 (EP) 21161027.4

(51) Int. Cl. C04B 24/12; C04B 22/10; C04B 22/14; C04B 24/02; C04B 24/06; C04B 24/16; C04B 24/26; C04B 28/14; C04B 103/10; C04B 103/20; C04B 103/30; C04B 111/00

(52) U.S. Cl. CPC C04B 24/126; C04B 22/106; C04B 22/148; C04B 24/02; C04B 24/06; C04B 24/122; C04B 24/16; C04B 24/2647; C04B 28/14; C04B 2103/10; C04B 2103/20; C04B 2103/30; C04B 2111/00163

(57) ABSTRACT

The present application relates to a cementitious composition suitable to be applied to an object via a nozzle. The composition comprises a) 15-90% by weight of a cementitious binder, b) 0.02-3% by weight of an ettringite formation controller, c) 0.15-10% by weight of a magnesium salt accelerator and d) 0.02-2% by weight of a polyhydroxy compound A, and/or salts or esters thereof, wherein the polyhydroxy compound A is selected from polyalcohols with a carbon to oxygen ratio of C/O≥1 and mixtures 0 thereof, based on the total dry weight of the composition. Further a process for applying the composition onto a surface and a hardened structure obtained by the process is disclosed.

The present invention relates to a cementitious composition suitable to be applied to an object via a nozzle and a method of its application.

Today cementitious composition are applied to surfaces via a nozzle in a variety of applications. Specifically shotcrete applications and 3D printing are of particular importance.

The development of construction technologies using three-dimensional (3D) printing began in the late 1990s. Development of such technologies increased greatly in the 2010's and has since spread worldwide. Using concrete with specific additives for 3D printing enables the free-form construction of concrete structures that are irregular in form. The 3D printed concrete has a great potential on practical applications, such as the affordable housing construction in low-income countries and complex constructions where the formwork is difficult to manufacture. In order to comprehensively introduce 3D printed concrete there is a need for compositions with high compressive strength within hours of curing time without compromising on their pumpability and applicability via a nozzle.

Shotcrete (or sprayed concrete) is a mortar or concrete product which is conveyed from delivery equipment through, e.g., a hose, and projected pneumatically at high velocity onto a surface. Shotcrete was originally invented by Carl Ethan Akeley, who in 1911 took out the U.S. Pat. No. 991,814 on the machine he had developed. He used the method of blowing dry material out of a hose with compressed air, injecting water at the nozzle as it was released. The dry-mix process was used until the wet-mix process was devised in the 1950s. In the 1960s, an alternative method for gunning dry material with a rotary gun appeared, using a continuously fed open hopper. Used today for its versatility and durability for covering walls in mines, subways and automobile tunnels, it is also a viable means and method for placing structural concrete.

Shotcrete is further especially used to protect exposed rocks from degradation due to weathering and dedication, in addition to providing support to loosened rock blocks in broken or overstressed ground. Commonly, admixtures are introduced to the cement/aggregate mix to improve its physical properties.

In mining applications, there is a desire to reduce the time spent preparing excavations, shafts or tunnels to increase the productivity in such a structure without jeopardizing the workers' safety. In open excavations, when a lift is removed and as the newly exposed ground has limited stand up time, shotcrete is sprayed on first for stabilization and then rock bolts or some other means of support are installed for permanent support. In tunneling and mining, the exposed face is often sprayed with shotcrete until the next round is prepared for blasting. In addition, the tunnel surface is often sprayed with shotcrete until rock bolts or steel rings or concrete segmental linings can be installed.

Conventional shotcrete can set in only a few minutes, but it is relatively slow to harden, taking several days to attain most of its strength. This means there is a significant delay after the shotcrete has been sprayed whilst it hardens until it is safe to resume mining activities in the vicinity of the shotcrete. This delay depends on what is considered to be an acceptable strength the concrete needs to attain. This time delay slows down mining operations and limits the applications in which shotcrete may be used. The time delay could be minimized by using a shotcrete composition which hardens quickly and develops high early strengths. Especially under difficult working conditions like unstable ground, where fast rates of advance are required, or if thick layers have to be sprayed overhead, high early strength of shotcrete is crucial.

Another problem in making cementitious composition which are applied to surfaces via a nozzle is the trade-off between setting time and early strength development, and the pumpability and applicability of the cementitious composition. Improving pumpability will minimize power consumption and blockages risk.

In addition, there is a need for cementitious compositions which are suitable for application at colder conditions, e.g., for use in winter construction.

WO 2017/212045 A1 describes construction chemical compositions comprising a bisulfite adduct of glyoxylic acid or salts thereof and an inorganic binder. The composition is described to advantageously affect mortar properties such as open time, processability, setting and compressive strength.

WO 2020/212607 A1 describes a shotcrete composition comprising a) a cementitious binder; b) an ettringite formation controller comprising (i) a glyoxylic acid condensate and/or a glyoxylic acid adduct; and c) an alkali-free, aluminum-based shotcrete accelerator. However, the aluminum-based shotcrete accelerators used have the disadvantage that they are toxicologically questionable, in particular the aluminum sulfate or aluminum chloride that is preferably used. These must therefore be labeled in the EU as of a proportion of 3 wt. % of aluminum sulfate or 1 wt. % of aluminum chloride in the formulation. Their use in shotcrete applications is particularly problematic because they are preferably used in poorly ventilated environments, such as tunnels or underground.

WO2020244981 relates to an additive component comprising a component A and a component B, wherein component A comprises at least one hardening retarder selected from glyoxylic acid, salts thereof, condensation or addition products of glyoxylic acid or salts thereof, and mixtures thereof, and component B comprises at least one hardening accelerator selected from calcium-silicate-hydrate, calcium formate, calcium nitrate, calcium chloride, calcium hydroxide, lithium carbonate, lithium sulfate, potassium sulfate, sodium sulfate, ground gypsum, and combinations thereof. Further the application of the additives in 3D printing of a construction material composition is disclosed.

There is therefore still a need for cementitious composition applicable to a surface via a nozzle with high compressive strength within hours of curing time without compromising their pumpability and applicability. In addition, there is still a need for cementitious compositions that have an improved toxicological profile and can also be applied used in poorly ventilated environments via a nozzle without risk to health.

The above problems are solved by a composition suitable to be applied to an object via a nozzle comprising, based on the total dry weight of the composition,
a) 15-90% by weight of a cementitious binder;
b) 0.02-3% by weight of an ettringite formation controller comprising
   (i) a glyoxylic acid condensate and/or a glyoxylic acid adduct and/or glyoxylic acid;
c) 0.15-10% by weight of a magnesium salt accelerator;
d) 0.02-2% by weight of a polyhydroxy compound A and/or salts or esters thereof, wherein the polyhydroxy compound A is selected from polyalcohols with a carbon to oxygen ratio of C/O 1 and mixtures thereof.

The invention also relates to a process comprising
providing a composition comprising a) 15-90% by weight of a cementitious binder; b) 0.02-3% by weight of an ettringite formation controller comprising (i) a glyoxylic acid condensate and/or a glyoxylic acid adduct and/or glyoxylic acid; d) 0.02-2% by weight of a polyhydroxy compound A and/or salts or esters thereof, wherein the polyhydroxy compound A is selected from polyalcohols with a carbon to oxygen ratio of C/O 1 and mixtures thereof
admixing c) 0.15-10% by weight of a magnesium salt accelerator; and
applying the composition onto a surface to obtain a structure and allowing the structure to harden;
   wherein the % by weight are based on the total dry weight of the composition.

In a preferred embodiment, the structure is in the form of a layer.

The invention further relates to a hardened structure obtained by the above-mentioned process.

Upon hydration of a cementitious system, ettringite is generated in a rapid reaction. Ettringite is a calcium aluminum sulfate compound having the formula Ca₆Al₂(SO₄)₃*32 H₂O or alternatively 3 CaO*Al₂O₃*3 CaSO₄*32 H₂O. This reaction is responsible for the development of early compressive strength of the cementitious composition. Ettringite forms as long needle-like crystals. The newly formed small needle-like ettringite crystals, however, tend to deteriorate the workability or flowability of the cementitious composition. In addition, ettringite contains 32 moles of water in its stoichiometric formula. This means that upon ettringite formation a significant amount of water is bound in the solid crystals and the flowability of the composition is reduced.

According to the invention, an ettringite formation controller is added to the composition in order to delay the reaction and improve workability. Without being bound by theory, it is assumed that the controller delays the hydration onset by inhibiting the dissolution of the reactive cement components, in particular aluminates, and/or by masking the calcium ions thereby slowing down the hydration reaction.

Component a), the cementitious binder, is suitably selected from Portland cement, calcium aluminate cement and/or sulfoaluminate cement.

The mineralogical phases are indicated by their usual name followed by their cement notation. The primary compounds are represented in the cement notation by the oxide varieties: C for CaO, S for SiO₂, A for Al₂O₃, $ for SO₃, F for Fe₂O₃, H for H₂O; this notation is used throughout.

The term “Portland cement” denotes any cement compound containing Portland clinker, especially CEM I, II, III, IV and V within the meaning of standard EN 197-1, paragraph 5.2. A preferred cement is ordinary Portland cement (OPC) according to DIN EN 197-1 which may either contain calcium sulfate (<7% by weight) or is essentially free of calcium sulfate (<1% by weight). The phases constituting Portland cement mainly are alite (C₃S), belite (C₂S), calcium aluminate (C₃A), calcium ferroaluminate (C₄AF) and other minor phases. The alite (C₃S) provides primarily strength properties.

Calcium aluminate cement (also referred to as high aluminate cement) means a cement containing calcium aluminate phases. The term “aluminate phase” denotes any mineralogical phase resulting from the combination of aluminate (of chemical formula Al₂O₃, or “A” in cement notation), with other mineral species. The amount of alumina (in form of Al₂O₃) is ≥30% by weight of the total mass of the aluminate-containing cement as determined by means of X-ray fluorescence (XRF). More precisely, said mineralogical phase of aluminate type comprises tricalcium aluminate (C₃A), monocalcium aluminate (CA), mayenite (C₁₂A₇), tetracalcium aluminoferrite (C₄AF), or a combination of several of these phases.

Sulfoaluminate cement has a content of ye'elimite (of chemical formula 4CaO·3Al₂O₃·SO₃ or C₄A₃$ in cement notation) of greater than 15% by weight.

In an embodiment, the cementitious binder comprises a mixture of Portland cement and aluminate cement, or a mixture of Portland cement and sulfoaluminate cement or a mixture of Portland cement, aluminate cement and sulfoaluminate cement.

In an embodiment, where the cementitious binder contains an aluminate-containing cement, the composition may additionally contain at least one calcium sulfate source. The calcium sulfate source may be selected from calcium sulfate dihydrate, anhydrite, α- and β-hemihydrate, i.e. α-bassanite and β-bassanite, or mixtures thereof. Preferably the calcium sulfate source is α-bassanite and/or β-bassanite. In general, the calcium sulfate source is comprised in an amount of about 1 to about 20 wt.-%, based on the weight of the aluminate-containing cement. In an embodiment, the composition additionally contains at least one alkali metal sulfate like potassium sulfate or sodium sulfate, or aluminum sulfate.

The compositions may also contain latent hydraulic binders and/or pozzolanic binders. Typically, these latent hydraulic binders and/or pozzolanic binders are included in the cementitious composition prior to admixture of the magnesium salt accelerator. For the purposes of the present invention, a “latent hydraulic binder” is preferably a binder in which the molar ratio (CaO+MgO):SiO₂ is from 0.8 to 2.5 and particularly from 1.0 to 2.0. In general terms, the above-mentioned latent hydraulic binders can be selected from industrial and/or synthetic slag, in particular from blast furnace slag, electrothermal phosphorous slag, steel slag and mixtures thereof. The “pozzolanic binders” can generally be selected from amorphous silica, preferably precipitated silica, fumed silica and microsilica, ground glass, metakaolin, aluminosilicates, fly ash, preferably brown-coal fly ash and hard-coal fly ash, rice husk ash, natural pozzolans such as tuff, trass and volcanic ash, natural and synthetic zeolites and mixtures thereof.

The slag can be either industrial slag, i.e. waste products from industrial processes, or else synthetic slag. The latter can be advantageous because industrial slag is not always available in consistent quantity and quality.

Blast furnace slag (BFS) is a waste product of the glass furnace process. Other materials are granulated blast furnace slag (GBFS) and ground granulated blast furnace slag (GGBFS), which is granulated blast furnace slag that has been finely pulverized. Ground granulated blast furnace slag varies in terms of grinding fineness and grain size distribution, which depend on origin and treatment method, and grinding fineness influences reactivity here. The Blaine value is used as parameter for grinding fineness, and typically has an order of magnitude of from 200 to 1000 m² kg⁻¹, preferably from 300 to 500 m² kg⁻¹. Finer milling gives higher reactivity.

For the purposes of the present invention, the expression “blast furnace slag” is however intended to comprise materials resulting from all of the levels of treatment, milling, and quality mentioned (i.e. BFS, GBFS and GGBFS). Blast furnace slag generally comprises from 30 to 45% by weight of CaO, about 4 to 17% by weight of MgO, about 30 to 45% by weight of SiO₂ and about 5 to 15% by weight of Al₂O₃, typically about 40% by weight of CaO, about 10% by weight of MgO, about 35% by weight of SiO₂ and about 12% by weight of Al₂O₃.

Electrothermal phosphorous slag is a waste product of electrothermal phosphorous production. It is less reactive than blast furnace slag and comprises about 45 to 50% by weight of CaO, about 0.5 to 3% by weight of MgO, about 38 to 43% by weight of SiO₂, about 2 to 5% by weight of Al₂O₃ and about 0.2 to 3% by weight of Fe₂O₃, and also fluoride and phosphate. Steel slag is a waste product of various steel production processes with greatly varying composition.

Amorphous silica is preferably an X ray-amorphous silica, i.e. a silica for which the powder diffraction method reveals no crystallinity. The content of SiO₂ in the amorphous silica of the invention is advantageously at least 80% by weight, preferably at least 90% by weight. Precipitated silica is obtained on an industrial scale by way of precipitating processes starting from water glass. Precipitated silica from some production processes is also called silica gel.

Fumed silica is produced via reaction of chlorosilanes, for example silicon tetrachloride, in a hydrogen/oxygen flame. Fumed silica is an amorphous SiO₂ powder of particle diameter from 5 to 50 nm with specific surface area of from 50 to 600 m² g⁻¹.

Microsilica is a by-product of silicon production or ferrosilicon production, and likewise consists mostly of amorphous SiO₂ powder. The particles have diameters of the order of magnitude of 0.1 μm. Specific surface area is of the order of magnitude of from 15 to 30 m² g⁻¹.

Fly ash is produced inter alia during the combustion of coal in power stations. Class C fly ash (brown-coal fly ash) comprises according to WO 08/012438 about 10% by weight of CaO, whereas class F fly ash (hard-coal fly ash) comprises less than 8% by weight, preferably less than 4% by weight, and typically about 2% by weight of CaO.

Metakaolin is produced when kaolin is dehydrated. Whereas at from 100 to 200° C. kaolin releases physically bound water, at from 500 to 800° C. a dehydroxylation takes place, with collapse of the lattice structure and formation of metakaolin (Al₂Si₂O₇). Accordingly, pure metakaolin comprises about 54% by weight of SiO₂ and about 46% by weight of Al₂O₃.

For the purposes of the present invention, aluminosilicates are the above-mentioned reactive compounds based on SiO₂ in conjunction with Al₂O₃ which harden in an aqueous alkali environment. It is of course not essential here that silicon and aluminum are present in oxidic form, as is the case by way of example in Al₂Si₂O₇. However, for the purposes of quantitative chemical analysis of aluminosilicates it is usual to state the proportions of silicon and aluminum in oxidic form (i.e. as “SiO₂” and “Al₂O₃”).

The composition according to the invention can be for example concrete, mortar or grouts. The term “mortar” or “grout” denotes a cement paste which contains fine aggregates, i.e. aggregates whose diameter is between 150 μm and 4 mm (for example sand), and optionally very fine granulates. A grout is a mixture of sufficiently low viscosity for filling in voids or gaps. Mortar viscosity is high enough to support not only the mortar's own weight but also that of masonry placed above it. The term “concrete” denotes a cement paste which contains coarse aggregates, i.e. aggregates with a diameter of greater than 4 mm.

The proportion of component a) by weight, based on the total dry weight of the composition, is in the range from 15-90% by weight, preferably from 20 to 80% by weight, particularly preferably from 25 to 60% by weight, most preferably from 25 to 40% by weight.

Component b) is at least one ettringite formation controller comprising (i) a glyoxylic acid condensate, glyoxylic acid adduct or glyoxylic acid, and mixtures thereof. It is believed that the glyoxylic acid condensate, glyoxylic acid adduct and glyoxylic acid suppresses the formation of ettringite from the aluminate phases originating from the cementitious binder by stabilizing the aluminate phases and thereby slowing down the dissolution of the aluminate phases.

Glyoxylic acid has in general the following structure:

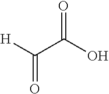

As used herein, salts of glyoxylic acid include the alkali, alkaline earth, zinc, iron, aluminium, ammonium, and phosphonium salts of glyoxylic acid. As used herein, addition products of glyoxylic acid or salts thereof refer to products, which are obtainable by reacting a nucleophilic compound with the α-carbonyl group of glyoxylic acid, so as to obtain α-substituted α-hydroxy-acetic acid or a salt thereof as an adduct. As used herein, condensation products of glyoxylic acid or salts thereof refer to condensation products obtainable by reacting a compound containing at least one amino or amido group with the α-carbonyl group of glyoxylic acid, such that water is set free. Examples of compounds containing at least one amino or amido group include urea, thiourea, melamine, guanidine, acetoguanamine, benzoguanamine and other acyl-guanamines, polyvinylamine and polyacrylamide.

In one embodiment, the addition product of glyoxylic acid under component b) is a bisulfite adduct of glyoxylic acid or a salt or a mixed salt thereof, wherein the bisulfite adduct preferably has the general formula (I):

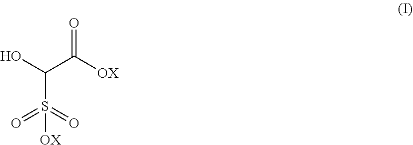

wherein X is in each case independently selected from H or a cation equivalent Kₐ, wherein K is an alkali metal, alkaline earth metal, zinc, iron, aluminium, ammonium, or a phosphonium cation, and wherein a is 1/n, wherein n is the valence of the cation. More preferably, X is H or Kₐ, wherein K is an alkali metal. Even more preferably K is lithium, sodium or potassium. It is to be understood that also mixed salts are possible.

In a particularly preferred embodiment X is independently sodium or potassium or a mixture thereof.

The bisulfite adducts are commercially available or can be prepared by conventional methods which are known to the skilled person. See, e.g., WO 2017/212045 A1 for further details in this regard.

In another embodiment, component b) is glyoxylic acid or a salt thereof. Preferably, component b) is a compound of the following formula (II):

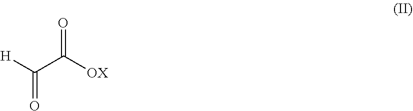

wherein X is selected from H or a cation equivalent Kₐ, wherein K is an alkali metal, alkaline earth metal, zinc, iron, aluminium, ammonium, or a phosphonium cation, and wherein a is 1/n, wherein n is the valence of the cation. More preferably, X is H or Kₐ, wherein K is an alkali metal. Even more preferably K is lithium, sodium or potassium. It is to be understood that also mixed salts are possible. In a particularly preferred embodiment X is sodium or potassium or a mixture thereof.

In yet another embodiment, component b) is a condensation product of glyoxylic acid or a salt thereof. Preferably, component b) is a compound (III) selected from the group consisting of a melamine-glyoxylic acid condensate, an urea-glyoxylic acid condensate, a melamine-urea-glyoxylic acid condensate and a polyacrylamide-glyoxylic acid condensate. Preferably, the amine-glyoxylic acid condensate is an urea-glyoxylic acid condensate.

The amine-glyoxylic acid condensates are obtainable by reacting glyoxylic acid with a compound containing aldehyde-reactive amino or amido groups. The glyoxylic acid can be used as an aqueous solution or as glyoxylic acid salts, preferably glyoxylic acid alkaline metal salts. Likewise, the amine compound can be used as salt, for example as guanidinium salts. In general, the amine compound and the glyoxylic acid are reacted in a molar ratio of 0.5 to 2 equivalents, preferably 1 to 1.3 equivalents, of glyoxylic acid per aldehyde-reactive amino or amido group. The reaction is carried out at a temperature of 0 to 120° C., preferably 25 to 105° C., most preferably 30 to 50° C. The pH value is preferably from 0 to 8. The viscous products obtained in the reaction can be used as such, adjusted to a desired solids content by dilution or concentration or evaporated to dryness by, e.g., spray-drying, drum-drying, or flash-drying.

In general, the amine-glyoxylic acid condensates have molecular weights in the range of from 500 to 25000 g/mol, preferably 1000 to 10000 g/mol, particularly preferred 1000 to 5000 g/mol. The molecular weight is measured by the gel permeation chromatography method (GPC) as indicated in detail in the experimental part.

Thus, in one embodiment, the compound component b) is selected from

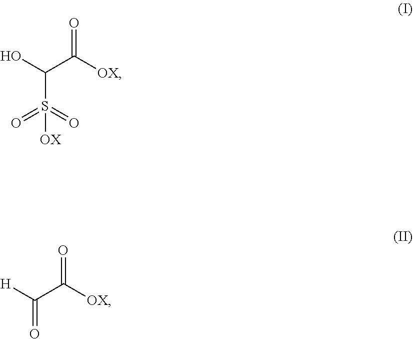

and
(III) an amine-glyoxylic acid condensate selected from the group consisting of a melamine-glyoxylic acid condensate, an urea-glyoxylic acid condensate, a melamine-urea-glyoxylic acid condensate and a polyacrylamide-glyoxylic acid condensate; and mixtures thereof; wherein X is in each case independently selected from H or a cation equivalent Kₐ, wherein K is an alkali metal, alkaline earth metal, zinc, iron, aluminium, ammonium, or a phosphonium cation, and wherein a is 1/n, wherein n is the valence of the cation.

In a preferred embodiment, the component b) is selected from

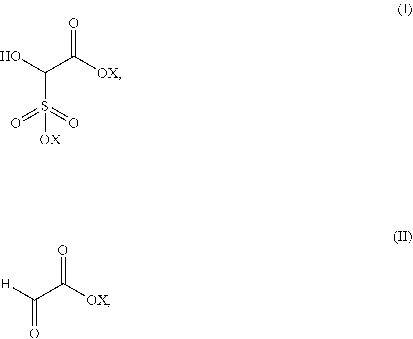

and
(III) an urea-glyoxylic acid condensate;
and mixtures thereof;
wherein X is in each case independently selected from H or a cation equivalent Kₐ,
wherein K is an alkali metal, alkaline earth metal, zinc, iron, aluminium, ammonium, or a phosphonium cation, and wherein a is 1/n, wherein n is the valence of the cation, and wherein preferably X is in each case independently selected from H and alkali metals, in particular from sodium, potassium, and mixtures thereof.

The proportion of component b) by weight, based on the total dry weight of the composition, is in the range from 0.02 to 3% by weight, preferably from 0,045 to 0.9% by weight, particularly preferably from 0.07 to 0.6% by weight.

Component c) is at least one magnesium salt accelerator. In a preferred embodiment, the magnesium salt accelerator is selected from magnesium salts with a solubility of more than 100 g/liter, preferably 150 g/liter, more preferably 200 g/liter and most preferably more than 250 g/liter at 20° C.

The magnesium salt accelerator of the inventive compositions is preferably based on magnesium salts such as sulfates, nitrates, fluorides, chlorides and/or their hydrates. Preferably, the alkali-free accelerator is magnesium sulfate.

The proportion of component c) by weight, based on the total dry weight of the composition, is in the range from 0.15 to 10% by weight, preferably from 0.3 to 5% by weight, most preferably from 1 to 3% by weight.

In one embodiment, the composition according to the invention comprises less than 0.1% by weight of an alkali-free, aluminum-based accelerator based on the total dry weight of the composition. The alkali-free aluminum-based accelerators may be selected from aluminum salts, aluminum complexes, aluminum oxides, aluminum hydroxides, and mixtures thereof. Preferably, the alkali-free accelerator is selected from aluminum salts, especially aluminum sulfates. In a preferred embodiment, the composition according to the invention does not comprise an alkali-free, aluminum-based accelerator.

Component d) is a polyhydroxy compound A and/or salts or esters thereof, wherein the polyhydroxy compound A is selected from polyalcohols with a carbon to oxygen ratio of C/O≥1, preferably from C/O≥1 to C/O 2, more preferably from C/O≥1 to C/O≤1.25, and mixtures thereof.

As used herein, the term polyhydroxy compound refers to an organic compound comprising at least two, preferably at least three hydroxy groups. The carbon chain of the compound may be linear or cyclic. Preferably the polyhydroxy compound only comprises carbon, oxygen, hydrogen, and optionally nitrogen atoms.

In a preferred embodiment the polyhydroxy compound A has a molecular weight of from 62 g/mol to 25000 g/mol, preferably from 62 g/mol to 10000 g/mol and most preferably from 62 g/mol to 1000 g/mol.

In another preferred embodiment, the polyhydroxy compound A is selected from sugar alcohols and their condensation products, alkanolamines and their condensation products, carbohydrates, pentaerythritol, trimethylolpropane, and mixture thereof.

As used herein, sugar alcohols preferably include sugar alcohols based on C₃-C₁₂-sugar molecules. Preferred sugar alcohols include glycerol, threitol, erythritol, xylitol, sorbitol, inositol, mannitol, maltitol, and lactitol. A particularly preferred sugar alcohol is glycerol having the following formula:

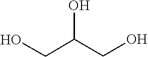

As used herein, the term alkanolamines refers to polyhydroxy compounds comprising at least one amino group. Exemplary alkanolamines include diethanolamine, methyl diethanolamine, butyl diethanolamine, monoisopropanolamine, diisopropanolamine, methyl diisopropanolamine, triethanolamine, tetrahydroxypropylethylenediamine, trimethylaminoethylethanolamine, N,N-bis(2-hydroxyethyl)isopropanolamine, N,N,N′-trimethylaminoethylethanolamine, and N,N,N′,N′-tetrakis(2-hydroxypropyl)ethylenediamine.

As used herein, the term carbohydrate refers to sugars, starch, and cellulose. Preferably, the term carbohydrate is intended to refer to sugars, i.e. mono- and disaccharides. Preferred carbohydrates according to the invention include glucose, fructose, sucrose, and lactose.

In a more preferred embodiment of the invention, the polyhydroxy compound A is selected from glycerol, threitol, erythritol, xylitol, sorbitol, inositol, mannitol, maltitol, lactitol, pentaerythritol, trimethylolpropane, and mixture thereof. In a particularly preferred embodiment, the polyhydroxy compound A is glycerol.

As indicated above, the polyhydroxy compound A may also be used in the form of the salt or ester thereof.

Suitable salts include metal salts such as alkali metal, alkaline earth metal, zinc, aluminium and iron salts, ammonium salts, and phosphonium salts. Preferred are metal salts, in particular alkali or earth alkali metal salts. Especially preferred are calcium salts.

Suitable esters include saturated or unsaturated C₁-C₂₀-carboxylic acid esters, preferably C₂-C₁₀-carboxylic acid esters, such as acetic acid esters. The carboxylic acid moiety may be unsubstituted or substituted by one or more substituents selected from halogen, OH, and ═O.

The proportion of component d) by weight, based on the total dry weight of the composition, is in the range from 0.02-2% by weight, preferably from 0,075 to 1.8% by weight, most preferably from 0.1 to 1.3% by weight.

In a preferred embodiment, the composition additionally comprises e) a carbonate source. It has surprisingly been found that components b), d) and e) act in a synergistic fashion. The presence of the carbonate source ensures that the mixing water is initially highly concentrated in carbonate ions. Carbonate ions are believed to inhibit the crystallization of ettringite. The carbonate source may be an inorganic carbonate having an aqueous solubility of 0.1 gL⁻¹ or more. The aqueous solubility of the inorganic carbonate is determined in water at pH 7 and 20° C. These characteristics are well known to those skilled in the art.

The “inorganic carbonate” is intended to mean a salt of carbonic acid, i.e., a salt which is characterized by the presence of a carbonate ion (CO₃²⁻) and/or hydrogen carbonate ion (HCO₃⁻).

The inorganic carbonate may be suitably selected from alkali metal carbonates such as sodium carbonate or lithium carbonate, and alkaline earth metal carbonates satisfying the required aqueous solubility, such as sodium carbonate. Further suitable inorganic carbonates include carbonates of nitrogenous bases such as guanidinium carbonate und ammonium carbonate.

Alternatively, the carbonate source is selected from organic carbonates. “Organic carbonate” denotes an ester of carbonic acid. The organic carbonate is hydrolyzed in the presence of the cementitious system to release carbonate ions. In an embodiment, the organic carbonate is selected from ethylene carbonate, propylene carbonate, glycerol carbonate, dimethyl carbonate, di(hydroxyethyl)carbonate or a mixture thereof, preferably ethylene carbonate, propylene carbonate, and glycerol carbonate or a mixture thereof, and in particular ethylene carbonate and/or propylene carbonate. Mixtures of inorganic carbonates and organic carbonates can as well be used.

The proportion of component e) by weight, based on the total dry weight of the composition, is preferably in the range from 0.04 to 2.0% by weight, most preferably from 0.1 to 1.0% by weight.

In an embodiment, the ettringite formation controller component b) further comprises
(ii) a component selected from
   polycarboxylic acids or salts thereof whose milliequivalent number of carboxyl groups is 5.00 meq/g or higher, preferably 5.00 to 15.00 meq/g, assuming all the carboxyl groups to be in unneutralized form; and
   α-hydroxy carboxylic acids or salts thereof.

By the term polycarboxylic acid, as used herein, is meant a compound or polymer having two or more carboxyl groups to the molecule.

Suitable polycarboxylic acids are
low molecular weight polycarboxylic acids (having a molecular weight of, e.g., 500 g/mol or lower), in particular aliphatic polycarboxylic acids, such as oxalic acid, malonic acid, succinic acid, glutaric acid, adipic acid, pimelic acid, fumaric acid, maleic acid, itaconic acid, citraconic acid, mesaconic acid, or malic acid;
phosphonoalkylcarboxylic acids, such as 1-phosphonobutane-1,2,4-tricarboxylic acid, 2-phosphonobutane-1,2,4-tricarboxylic acid, 3-phosphonobutane-1,2,4-tricarboxylic acid, 4-phosphonobutane-1,2,4-tricarboxylic acid, 2,4-diphosphonobutane-1,2,4-tricarboxylic acid, 2-phosphonobutane-1,2,3,4-tetracarboxylic acid, 1-methyl-2-phosphonopentane-1,2,4-tricarboxylic acid, or 1,2-phosphonoethane-2-dicarboxylic acid;
amino carboxylic acids, such as ethylenediamine tetra acetic acid, or nitrilotriacetic acid;
polymeric carboxylic acids, such as homopolymers of acrylic acid, homopolymers of methacrylic acid, polymaleic acid, copolymers such as ethylene/acrylic acid copolymer and ethylene/methacrylic acid copolymer; copolymers of acrylic acid and/or methacrylic acid with sulfo or sulfonate group containing monomers. In an embodiment, the sulfo or sulfonate group containing monomers are selected from the group of vinylsulfonic acid, (meth)allylsulfonic acid, 4-vinylphenylsulfonic acid or 2-acrylamido-2-methylpropylsulfonic acid (ATBS), with ATBS being particularly preferred. It is possible that one more of the before mentioned sulfo or sulfonate group containing monomers are contained in the copolymers.

In general, the molecular weight of the polymeric carboxylic acids is in the range of from 1000 to 30 000 g/mol, preferably 1000 to 10 000 g/mol.

Suitable α-hydroxy carboxylic acids or salts thereof include tartaric acid, citric acid, glycolic acid, gluconic acid, and their salts and mixtures thereof. Sodium gluconate is particularly preferred.

The weight ratio of component (i) to component (ii) in component b) is preferably in the range from about 10:1 to about 1:10, preferably about 5:1 to about 1:5 or about 3:1 to about 1:1, based on the dry weight of the components (i) and (ii).

The ettringite formation controller can be present as a solution or dispersion, in particular an aqueous solution or dispersion. The solution or dispersion suitably has a solids content of 10 to 50% by weight, in particular 25 to 35% by weight. Alternatively, the ettringite formation controller can be present as a powder which is obtainable, e.g., by drum-drying, spray-drying or flash-drying. The ettringite formation controller may be introduced into the mixing water or introduced during the mixing of the mortar or concrete before addition of water.

The composition may comprise additional ingredients which are conventional in the art and which are exemplified below. The composition is admixed with water. The composition admixed with water is also referred to as “cement paste”.

Preferably, the composition according to the invention additionally comprises at least one dispersant for inorganic binders, especially a dispersant for cementitious mixtures like concrete or mortar. Preferably, the dispersant is included in the composition prior to admixture of the magnesium salt accelerator.

The dispersant is preferably selected from the group of
comb polymers having a carbon-containing backbone to which are attached pendant cement-anchoring groups and polyether side chains,
non-ionic comb polymers having a carbon-containing backbone to which are attached pendant hydrolysable groups and polyether side chains, the hydrolysable groups upon hydrolysis releasing cement-anchoring groups,
sulfonated melamine-formaldehyde condensates,
lignosulfonates,
sulfonated ketone-formaldehyde condensates,
sulfonated naphthalene-formaldehyde condensates,
phosphonate containing dispersants,
phosphate containing dispersants, and
mixtures thereof.

In an embodiment, the dispersant is a comb polymer having a carbon-containing backbone to which are attached pendant cement-anchoring groups and polyether side chains. The cement-anchoring groups are anionic and/or anionogenic groups such as carboxylic groups, phosphonic or phosphoric acid groups or their anions. Anionogenic groups are the acid groups present in the polymeric dispersant, which can be transformed to the respective anionic group under alkaline conditions.

Preferably, the structural unit comprising anionic and/or anionogenic groups is one of the general formulae (Ia), (Ib), (Ic) and/or (Id):

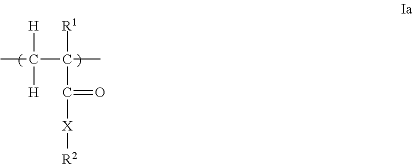

wherein
R¹ is H, C₁-C₄ alkyl, CH₂COOH or CH₂CO—X—R^{3A}, preferably H or methyl;
X is NH—(Cₙ₁H₂ₙ₁) or O—(Cₙ₁H₂ₙ₁) with n1=1, 2, 3 or 4, or a chemical bond, the nitrogen atom or the oxygen atom being bonded to the CO group;
R² is OM, PO₃M₂, or O—PO₃M₂; with the proviso that X is a chemical bond if R² is OM;
R^{3A} is PO₃M₂, or O—PO₃M₂;

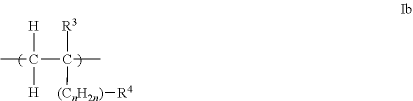

wherein
R³ is H or C₁-C₄ alkyl, preferably H or methyl;
n is 0, 1, 2, 3 or 4;
R⁴ is PO₃M₂, or O—PO₃M₂;

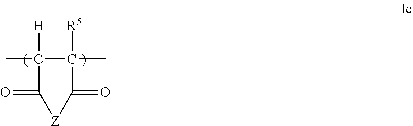

wherein
R⁵ is H or C₁-C₄ alkyl, preferably H;
Z is O or NR⁷;
R⁷ is H, (Cₙ₁H₂ₙ₁)—OH, (Cₙ₁H₂ₙ₁)—PO₃M₂, (Cₙ₁H₂ₙ₁)—OPO₃M₂, (C₆H₄)—PO₃M₂, or (C₆H₄)—OPO₃M₂, and
n1 is 1, 2, 3 or 4;

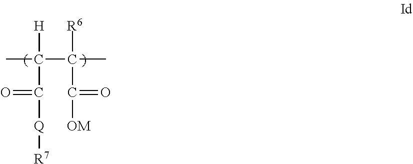

wherein
R⁶ is H or C₁-C₄ alkyl, preferably H;
Q is NR⁷ or O;
R⁷ is H, (Cₙ₁H₂ₙ₁)—OH, (Cₙ₁H₂ₙ₁)—PO₃M₂, (Cₙ₁H₂ₙ₁)—OPO₃M₂, (C₆H₄)—PO₃M₂, or (C₆H₄)—OPO₃M₂,
n1 is 1, 2, 3 or 4; and
where each M independently is H or a cation equivalent.

Preferably, the structural unit comprising a polyether side chain is one of the general formulae (IIa), (IIb), (IIc) and/or (IId):

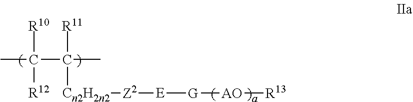

wherein
R¹⁰, R¹¹ and R¹² independently of one another are H or C₁-C₄ alkyl, preferably H or methyl;
Z² is O or S;
E is C₂-C₆ alkylene, cyclohexylene, CH₂—C₆H₁₀, 1,2-phenylene, 1,3-phenylene or 1,4-phenylene;
G is O, NH or CO—NH; or
E and G together are a chemical bond;
A is C₂-C₅ alkylene or CH₂CH(C₆H₅), preferably C₂-C₃ alkylene;
n2 is 0, 1, 2, 3, 4 or 5;
a is an integer from 2 to 350, preferably 10 to 150, more preferably 20 to 100;
R¹³ is H, an unbranched or branched C₁-C₄ alkyl group, CO—NH₂ or COCH₃;

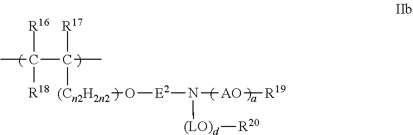

wherein
R¹⁶, R¹⁷ and R¹⁸ independently of one another are H or C₁-C₄ alkyl, preferably H;
E² is C₂-C₆ alkylene, cyclohexylene, CH₂—C₆H₁₀, 1,2-phenylene, 1,3-phenylene, or 1,4-phenylene, or is a chemical bond;
A is C₂-C₅ alkylene or CH₂CH(C₆H₅), preferably C₂-C₃ alkylene;
n2 is 0, 1, 2, 3, 4 or 5;
L is C₂-C₅ alkylene or CH₂CH(C₆H₅), preferably C₂-C₃ alkylene;
a is an integer from 2 to 350, preferably 10 to 150, more preferably 20 to 100;
d is an integer from 1 to 350, preferably 10 to 150, more preferably 20 to 100;
R¹⁹ is H or C₁-C₄ alkyl; and
R²⁰ is H or C₁-C₄ alkyl;

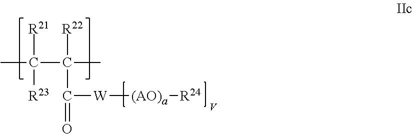

wherein
R²¹, R²² and R²³ independently are H or C₁-C₄ alkyl, preferably H;
W is O, NR²⁵, or is N;
V is 1 if W═O or NR²⁵, and is 2 if W═N;
A is C₂-C₅ alkylene or CH₂CH(C₆H₅), preferably C₂-C₃ alkylene;
a is an integer from 2 to 350, preferably 10 to 150, more preferably 20 to 100;
R²⁴ is H or C₁-C₄ alkyl;
R²⁵ is H or C₁-C₄ alkyl;

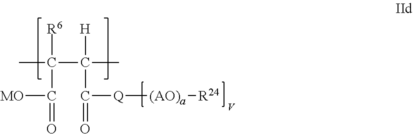

wherein
R⁶ is H or C₁-C₄ alkyl, preferably H;
Q is NR¹⁰, N or O;
V is 1 if Q=O or NR¹⁰ and is 2 if Q=N;
R¹⁰ is H or C₁-C₄ alkyl;
A is C₂-C₅ alkylene or CH₂CH(C₆H₅), preferably C₂-C₃ alkylene; and
a is an integer from 2 to 350, preferably 10 to 150, more preferably 20 to 100;
where each M independently is H or a cation equivalent.

The molar ratio of structural units (1) to structural units (II) varies from 1:3 to about 10:1, preferably 1:1 to 10:1, more preferably 3:1 to 6:1. The polymeric dispersants comprising structural units (1) and (II) can be prepared by conventional methods, for example by free radical polymerization. The preparation of the dispersants is, for example, described in EP 0 894 811, EP 1 851 256, EP 2 463 314, and EP 0 753 488.

A number of useful dispersants contain carboxyl groups, salts thereof or hydrolysable groups releasing carboxyl groups upon hydrolysis. Preferably, the milliequivalent number of carboxyl groups contained in these dispersants (or of carboxyl groups releasable upon hydrolysis of hydrolysable groups contained in the dispersant) is 4.90 meq/g or lower, assuming all the carboxyl groups to be in unneutralized form.

More preferably, the dispersant is selected from the group of polycarboxylate ethers (PCEs). In PCEs, the anionic groups are carboxylic groups and/or carboxylate groups. The PCE is preferably obtainable by radical copolymerization of a polyether macromonomer and a monomer comprising anionic and/or anionogenic groups. Preferably, at least 45 mol-%, preferably at least 80 mol-% of all structural units constituting the copolymer are structural units of the polyether macromonomer or the monomer comprising anionic and/or anionogenic groups.

A further class of suitable comb polymers having a carbon-containing backbone to which are attached pendant cement-anchoring groups and polyether side chains comprise structural units (III) and (IV):

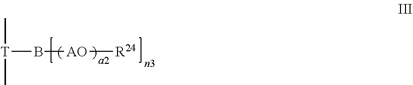

wherein
T is phenyl, naphthyl or heteroaryl having 5 to 10 ring atoms, of which 1 or 2 atoms are heteroatoms selected from N, O and S;
n3 is 1 or 2;
B is N, NH or O, with the proviso that n3 is 2 if B is N and n3 is 1 if B is NH or O;
A is C₂-C₅ alkylene or CH₂CH(C₆H₅), preferably C₂-C₃ alkylene;
a2 is an integer from 1 to 300;
R²⁶ is H, C₁-C₁₀ alkyl, C₅-C₅ cycloalkyl, aryl, or heteroaryl having 5 to 10 ring atoms, of which 1 or 2 atoms are heteroatoms selected from N, O and S;
where the structural unit (IV) is selected from the structural units (IVa) and (IVb):

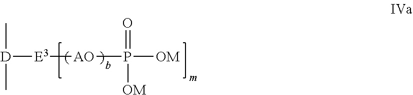

wherein
D is phenyl, naphthyl or heteroaryl having 5 to 10 ring atoms, of which 1 or 2 atoms are heteroatoms selected from N, O and S;
E³ is N, NH or O, with the proviso that m is 2 if E³ is N and m is 1 if E³ is NH or O;
A is C₂-C₅ alkylene or CH₂CH(C₆H₅), preferably C₂-C₃ alkylene;
b is an integer from 0 to 300;
M independently is H or a cation equivalent;

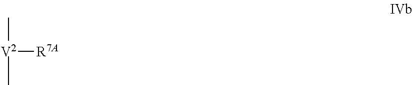

wherein
V² is phenyl or naphthyl and is optionally substituted by 1 or two radicals selected from R⁸, OH, OR⁸, (CO)R⁸, COOM, COOR⁸, SO₃R⁸ and NO₂;
R^{7A} is COOM, OCH₂COOM, SO₃M or OPO₃M₂;
M is H or a cation equivalent; and
R⁸ is C₁-C₄ alkyl, phenyl, naphthyl, phenyl-C₁-C₄ alkyl or C₁-C₄ alkylphenyl.

Polymers comprising structural units (III) and (IV) are obtainable by polycondensation of an aromatic or heteroaromatic compound having a polyoxyalkylene group attached to the aromatic or heteroaromatic core, an aromatic compound having a carboxylic, sulfonic or phosphate moiety, and an aldehyde compound such as formaldehyde.

In an embodiment, the dispersant is a non-ionic comb polymer having a carbon-containing backbone to which are attached pendant hydrolysable groups and polyether side chains, the hydrolysable groups upon hydrolysis releasing cement-anchoring groups. Conveniently, the structural unit comprising a polyether side chain is one of the general formulae (IIa), (IIb), (IIc) and/or (IId) discussed above. The structural unit having pendant hydrolysable groups is preferably derived from acrylic acid ester monomers, more preferably hydroxyalkyl acrylic monoesters and/or hydroxyalkyl diesters, most preferably hydroxypropyl acrylate and/or hydroxyethyl acrylate. The ester functionality will hydrolyze to (deprotonated) acid groups upon exposure to water at preferably alkaline pH, which is provided by mixing the cementitious binder with water, and the resulting acid functional groups will then form complexes with the cement component.

Suitable sulfonated melamine-formaldehyde condensates are of the kind frequently used as plasticizers for hydraulic binders (also referred to as MFS resins). Sulfonated melamine-formaldehyde condensates and their preparation are described in, for example, CA 2 172 004 A1, DE 44 1 1 797 A1, U.S. Pat. Nos. 4,430,469, 6,555,683 and CH 686 186 and also in Ullmann's Encyclopedia of Industrial Chemistry, 5th Ed., vol. A2, page 131, and Concrete Admixtures Handbook—Properties, Science and Technology, 2. Ed., pages 411, 412. Preferred sulfonated melamine-formaldehyde condensates encompass (greatly simplified and idealized) units of the formula

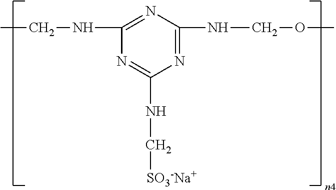

in which n4 stands generally for 10 to 300. The molar weight is situated preferably in the range from 2500 to 80 000. Additionally, to the sulfonated melamine units it is possible for other monomers to be incorporated by condensation. Particularly suitable is urea. Moreover, further aromatic units as well may be incorporated by condensation, such as gallic acid, aminobenzenesulfonic acid, sulfanilic acid, phenolsulfonic acid, aniline, ammoniobenzoic acid, dialkoxybenzenesulfonic acid, dialkoxybenzoic acid, pyridine, pyridinemonosulfonic acid, pyridinedisulfonic acid, pyridinecarboxylic acid and pyridinedicarboxylic acid. An example of melaminesulfonate-formaldehyde condensates are the Melment® products distributed by BASF Construction Additives GmbH.

Suitable lignosulfonates are products which are obtained as by-products in the paper industry. They are described in Ullmann's Encyclopedia of Industrial Chemistry, 5th Ed., vol. A8, pages 586, 587. They include units of the highly simplified and idealizing formula

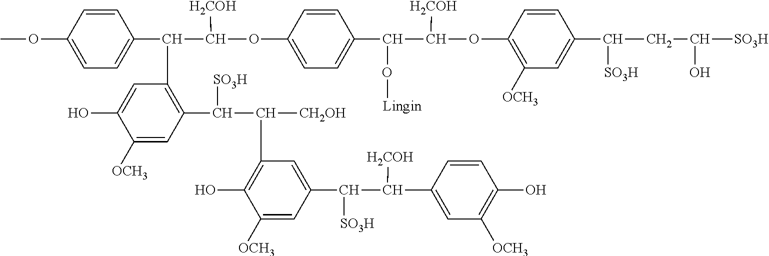

Lignosulfonates have molar weights of between 2000 and 100 000 g/mol. In general, they are present in the form of their sodium, calcium and/or magnesium salts. Examples of suitable lignosulfonates are the Borresperse products distributed by Borregaard LignoTech, Norway.

Suitable sulfonated ketone-formaldehyde condensates are products incorporating a monoketone or diketone as ketone component, preferably acetone, butanone, pentanone, hexanone or cyclohexanone. Condensates of this kind are known and are described in WO 2009/103579, for example. Sulfonated acetone-formaldehyde condensates are preferred. They generally comprise units of the formula (according to J. Plank et al., J. Appl. Poly. Sci. 2009, 2018-2024):

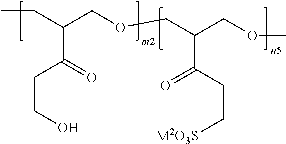

where m2 and n5 are generally each 10 to 250, M² is an alkali metal ion, such as Na⁺, and the ratio m2:n5 is in general in the range from about 3:1 to about 1:3, more particularly about 1.2:1 to 1:1.2. Furthermore, it is also possible for other aromatic units to be incorporated by condensation, such as gallic acid, aminobenzenesulfonic acid, sulfanilic acid, phenolsulfonic acid, aniline, ammoniobenzoic acid, dialkoxybenzenesulfonic acid, dialkoxybenzoic acid, pyridine, pyridinemonosulfonic acid, pyridinedisulfonic acid, pyridinecarboxylic acid and pyridinedicarboxylic acid. Examples of suitable sulfonated acetone-formaldehyde condensates are the Melcret K1L products distributed by BASF Construction Additives GmbH.

Suitable sulfonated naphthalene-formaldehyde condensates are products obtained by sulfonation of naphthalene and subsequent polycondensation with formaldehyde. They are described in references including Concrete Admixtures Handbook—Properties, Science and Technology, 2. Ed., pages 411-413 and in Ullmann's Encyclopedia of Industrial Chemistry, 5th Ed., vol. A8, pages 587, 588. They comprise units of the formula

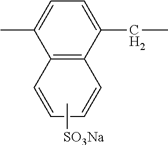

Typically, molar weights (Mw) of between 1000 and 50 000 g/mol are obtained. Furthermore, it is also possible for other aromatic units to be incorporated by condensation, such as gallic acid, aminobenzenesulfonic acid, sulfanilic acid, phenolsulfonic acid, aniline, ammoniobenzoic acid, dialkoxybenzenesulfonic acid, dialkoxybenzoic acid, pyridine, pyridinemonosulfonic acid, pyridinedisulfonic acid, pyridinecarboxylic acid and pyridinedicarboxylic acid. Examples of suitable sulfonated β-naphthalene-formaldehyde condensates are the Melcret 500 L products distributed by BASF Construction Additives GmbH.

Generally, phosphonate containing dispersants incorporate phosphonate groups and polyether side groups.

Suitable phosphonate containing dispersants are those according to the following formula

R—(OA²)ₘ₆-N—[CH₂—PO(OM³₂)₂]₂
wherein
R is H or a hydrocarbon residue, preferably a C₁-C₁₅ alkyl radical,
A² is independently C₂-C₁₈ alkylene, preferably ethylene and/or propylene, most preferably ethylene,
n6 is an integer from 5 to 500, preferably 10 to 200, most preferably 10 to 100, and
M³ is H, an alkali metal, ½ alkaline earth metal and/or an amine.

The proportion of dispersant by weight, based on the total dry weight of the composition, is preferably in the range from 0,001 to 0.9% by weight, most preferably from 0,005 to 0.1% by weight.

The composition according to this invention may further comprise aggregates, for example silica, quartz, sand, crushed marble, glass spheres, granite, basalt, limestone, sandstone, calcite, marble, serpentine, travertine, dolomite, feldspar, gneiss, alluvial sands, any other durable aggregate, and mixtures thereof. The aggregates are often also called fillers and in particular do not work as a binder.

The proportion of aggregates by weight, based on the total dry weight of the composition, is preferably in the range from 5 to 84.8% by weight.

The composition may further comprise additives such as:
grinding aids, like amines, amino alcohols, glycols, glycol derivatives, molasses, corn syrup;
nucleating agents, like calcium silicate hydrate compounds in finely grained form;
strength enhancers, like alkali metal hydroxides, alkaline earth metal hydroxides, alkali metal oxides, alkaline earth metal oxides, alkali metal nitrates, alkaline earth metal nitrates, alkali metal nitrites, alkaline earth metal nitrites, alkali metal thiocyanates, alkaline earth metal thiocyanates, alkali metal halides alkaline earth metal halides and alkaline earth metal formates;
set retarders like sucrose, glucose, polymeric sugars and phosphonic acids;
mechanical reinforcement, like synthetic polymeric fibers (for example polypropylene), natural fibers, steel fibers, or meshes of these materials;
stabilizers or thickeners like cellulose ethers and cellulose derivatives, starch, starch ethers and other starch derivatives, xanthan gums, welan gums, diutan gums, high molecular weight polyacrylamides and copolymers thereof comprising acrylic acid and/or ATBS;
polymer dispersions in liquid form or in solid form, such as powder form, like polyacrylates, styrene-butadiene copolymers and ethylene-vinyl acetate copolymers; and
mixtures thereof.

Typically, these additives are included in component a) prior to admixing the component c).

The process according to the invention comprises:
providing a composition comprising a) 15-90 by weight of a cementitious binder; b) 0.02-3% by weight of an ettringite formation controller comprising (i) a glyoxylic acid condensate and/or a glyoxylic acid adduct and/or glyoxylic acid; d) 0.02-2% by weight of a polyhydroxy compound A and/or salts or esters thereof, wherein the polyhydroxy compound A is selected from polyalcohols with a carbon to oxygen ratio of C/O≥1 and mixtures thereof;
admixing an c) 0.15-10% by weight of a magnesium salt accelerator; and
applying the composition onto a surface to obtain a structure and allowing the structure to harden,
   wherein the % by weight are based on the total dry weight of the composition.

Preferably, the composition is pneumatically projected onto the surface.

In one embodiment, the magnesium salt accelerator c) is admixed to the composition using a static mixing device, such as an extruder or a standard sprayed concrete nozzle, or a dynamic mixing device, such as a standard mechanical mixer like a concrete mixer. The components b) and d) may be admixed to the composition in the form of an aqueous solution, in the form of an aqueous suspension, in the form of a solid, or a mixture of these forms.

In one embodiment, the process of the invention can be used in shotcrete applications. There are two basic shotcreting technologies, for both of which the present process is applicable: the “dry” process, in which a mixture of cement, fine and/or coarse aggregates and a powder accelerator is pneumatically conveyed through a nozzle to a delivery hose where water is added through a water ring to the essentially dry materials; and the “wet” process, in which the cement, aggregates and water are mixed to a plastic consistency before being conveyed hydraulically to the nozzle where compressed air is added to pneumatically project the wet material onto the surface. However, further “mixed” shotcreting technologies exist.

In a further embodiment, the process of the invention can be used for 3D-printing of various articles, which can be used for construction, decorative and further purposes.

The invention will be described in more detail by the accompanying examples.

### EXAMPLES

### A.) Materials

Binder: OPC CEM I Bernburg 42.5 R and calcium sulfate anhydride CAB 30 from Knauf.

Plasticiziser: Melflux 6680 L, available from BASF Construction Additives GmbH, a polycarboxylate ether (PCE) based plasticizers was used.

As accelerators were used:
Aluminium sulfate octadecahydrate from Sigma Aldrich (reference)
MasterRoc SA 160 from BASF Construction Solutions GmbH. MasterRoc SA 160 is an aqueous suspension type alkali-free accelerator based on aluminum sulfate with solid content in the range of 50±4%. (reference)
Magnesium sulfate hydrate from Riedel-de-Haen (invention)
HyCon® S 3200 F is a calcium silicate hydrate hardening accelerator in powder form from BASF Construction Additives GmbH

The retarder mixture contains:
a) Glyoxylic acid urea condensate
b) Sodium gluconate
c) Glycerol from Sigma-Aldrich and triethanolamine from Sigma-Aldrich as polyolcomponent
d) Sodium bicarbonate from Sigma-Aldrich

| | | Content as solid in wt.-% | | |
|---|---|---|---|---|
| | | VZ F4 | VZ F35 | VZ F42 |
| A | Glyoxylic acid urea condensate | 20.1 | 29.7 | 14.93 |
| B | Sodium gluconate | 6.71 | 9.90 | 4.98 |
| C | Glycerol from Sigma-Aldrich | 32.2 | 0 | 49.75 |
| | and triethanolamine from | | | |
| | Sigma-Aldrich ratio 2:1 | | | |
| D | Sodium bicarbonate from | 40.9 | 60.4 | 30.35 |
| | Sigma-Aldrich | | | |

| | 1.5 wt.-%¹ | 1.01 wt.-%¹ | 2.0 wt.-%¹ |
|---|---|---|---|
| | VZ F4 | VZ F35 | VZ F42 |
| Glyoxylic acid urea condensate | 0.30¹ | 0.30¹ | 0.30¹ |
| Sodium gluconate | 0.10¹ | 0.10¹ | 0.10¹ |
| Glycerol from Sigma-Aldrich | 0.48¹ | 0.00 | 1.00¹ |
| and triethanolamine from | | | |
| Sigma-Aldrich ratio 2:1 | | | |
| Sodium bicarbonate from | 0.61¹ | 0.61¹ | 0.61¹ |
| Sigma-Aldrich | | | |

¹wt.-% of the sum of solid of active components relative to the weight of binder (cement plus anhydride)

The glyoxylic acid urea condensate was synthesized as follows: Glyoxylic acid (1.2 g of glyoxylic acid, 50 wt.-% solution in water) was charged into a reaction vessel and aqueous potassium hydroxide (40 wt.-%) was added until a pH value of 5 was reached. 1 g of urea was added and the mixture was heated to 80° C. The thus obtained glyoxylic acid urea condensate (Mₙ=950 g/mol) is an aqueous solution with a solids content of 49.3%.

### B. Analytical Methods

Gel Permeation Chromatography (GPC)

Column combination: OH-Pak SB-G, OH-Pak SB 804 HQ and OH-Pak SB 802.5 HQ by Shodex, Japan; eluent: 80 vol.-% aqueous solution of HCO₂NH₄ (0.05 mol/1) and 20 vol.-% Methanol; injection volume 100 μl; flow rate 0.5 ml/min. The molecular weight calibration was performed with poly(acrylate) standards for the RI detector, purchased from PSS Polymer Standards Service, Germany.

### C. Application Test

The compounded mortar had a sand/binder ratio of s/b=2.2. The sand was a mixture of 70% norm sand and 30% quartz sand. The water/binder weight ratio was 0.42. The amounts of additives are listed in table 1, 2 and 3.

The mortar was prepared in a 5 L RILEM mixer. The mixer was charged with the binder cement and gypsum anhydride. The plasticizer and the ettringite formation controlling agent are added to the mixing water. The mixing procedure are shown in the table.

| Time in | Mixing | |
|---|---|---|
| seconds | Speed | Note |
| 0 | I | Addition mixing water to binder, start slow mixing |
| 30 | I | Sand is added to the paste |
| 60 | II | Fast mixing |
| 90 | 0 | Stop mixing |
| 180 | II | Start mixing |
| 240 | 0 | End of mixing |

For the mortar tests with setting accelerators, the accelerator was mixed with RILEM mixer in the mortar for ten seconds with mixing speed 1. The accelerator was added to the fresh mortar after the time shown in table 1 and 2. After the ten seconds consecutive mixing, the final mortar is filled into 4×4×16 cm prism molds, densified at a vibrating table for 1 minute, sealed and stored at 20° C. and 50% relative humidity. The initial setting was determined with a Vicat apparatus according to DIN EN 196-3. The strength was measured according to DIN EN 196-1.

TABLE 1

| | Mortar Mix | | | |
|---|---|---|---|---|
| Component | M1 | M2 | M3 | M4 |
| Cement [g] | 832.82 | 832.82 | 832.82 | 832.82 |
| Gypsum anhydride [g] | 43.43 | 43.43 | 43.43 | 43.43 |
| Norm sand [g] (DIN EN 196-1) | 1350 | 1350 | 1350 | 1350 |
| Quartz sand 0.1-0.3 mm [g] | 567.87 | 567.87 | 567.87 | 567.87 |
| Melflux 6680L Plasticizer [wt-%]¹ | 0.04 | 0.04 | 0.04 | 0.04 |
| MasterRoc SA 160 | | | | 2.5 |
| Accelerator [wt.-%]² | | | | |
| Al₂(SO₄)₃*18H₂O [wt.-%]² | | | 2.5 | |
| MgSO₄ Hydrate | | | | |
| Accelerator [wt.-%]² | | | | |
| VZ F35 | | 1.01 | 1.01 | 1.01 |
| Ettringite formation | | | | |
| controller [wt.-%]² | | | | |
| Time Accelerator added after | 0 | 30 | 30 | 30 |
| Mortar mixing [min.] | | | | |
| Water [g] (total amount) | 368.03 | 368.03 | 368.03 | 368.03 |

¹wt.-% of the sum of solid of active components relative to the weight of cement (bwoc)
²wt.-% of the sum of solid of active components relative to the weight of binder (cement plus anhydride)

TABLE 2

| | Mortar Mix | | | | | | | | |
|---|---|---|---|---|---|---|---|---|---|
| Component | M5 | M6 | M7 | M8 | M9 | M10 | M11 | M12 | M13 |
| Cement [g] | 832.82 | 832.82 | 832.82 | 832.82 | 832.82 | 832.82 | 832.82 | 832.82 | 832.82 |
| Gypsum | 43.43 | 43.43 | 43.43 | 43.43 | 43.43 | 43.43 | 43.43 | 43.43 | 43.43 |
| anhydride [g] | | | | | | | | | |
| Norm sand [g] | 1350 | 1350 | 1350 | 1350 | 1350 | 1350 | 1350 | 1350 | 1350 |
| (DIN EN 196-1) | | | | | | | | | |
| Quartz sand | 567.87 | 567.87 | 567.87 | 567.87 | 567.87 | 567.87 | 567.87 | 567.87 | 567.87 |
| 0.1-0.3 mm [g] | | | | | | | | | |
| Melflux 6680L | 0.04 | 0.04 | 0.04 | 0.04 | 0.04 | 0.04 | 0.04 | 0.04 | 0.04 |
| Plasticizer | | | | | | | | | |
| in wt.-%¹ | | | | | | | | | |
| MgSO₄ Hydrate | 2.5 | 2.5³ | 2.5 | 2.5 | 2.5 | 2.5³ | 3.4 | 2.85 | 2.5 |
| Accelerator | | | | | | | | | |
| [wt.-%]² | | | | | | | | | |
| VZ F4 | | | 1.5 | 1.5 | 1.5 | 1.5 | 1.5 | 1.5 | |
| Ettringite for- | | | | | | | | | |
| mation controller | | | | | | | | | |
| [wt.-%]² | | | | | | | | | |
| VZ F35 | 1.01 | 1.01 | | | | | | | |
| Ettringite for- | | | | | | | | | |
| mation controller | | | | | | | | | |
| [wt.-%]² | | | | | | | | | |
| VZ F42 | | | | | | | | | 2.0 |
| Ettringite for- | | | | | | | | | |
| mation controller | | | | | | | | | |
| [wt.-%]² | | | | | | | | | |
| Time added | 30 | 30 | 30 | 60 | 90 | 30 | 30 | 30 | 30 |
| Accelerator after | | | | | | | | | |
| Mortar mixing | | | | | | | | | |
| [min.] | | | | | | | | | |
| Water [g] | 368.03 | 368.03 | 368.03 | 368.03 | 368.03 | 368.03 | 368.03 | 368.03 | 368.03 |
| (total amount) | | | | | | | | | |

¹wt.-% of the sum of solid of active components relative to the weight of cement (bwoc)
²wt.-% of the sum of solid of active components relative to the weight of binder (cement plus anhydride)
³Accelerator added as solution with a solid content of 30%

TABLE 3

| | Mortar Mix | | | |
|---|---|---|---|---|
| Component | M14 | M15 | M16 | M17 |
| Cement [g] | 832.82 | 832.82 | 832.82 | 832.83 |
| Gypsum | 43.43 | 43.43 | 43.43 | 43.43 |
| anhydride [g] | | | | |
| Norm sand [g] | 1350 | 1350 | 1350 | 1350 |
| (DIN EN 196-1) | | | | |
| Quartz sand | 567.87 | 567.87 | 567.87 | 567.87 |
| 0.1-0.3 mm [g] | | | | |
| Melflux 6680L | 0.04 | 0.04 | 0.04 | 0.04 |
| Plasticizer | | | | |
| in wt.-%¹ | | | | |
| Ca(OH)₂ | 2.23 | 2.5 | 4.26 | 5 |
| [wt.-%]² | | | | |
| HyCon ® S 3200 F | 0.27 | | 0.54 | |
| [wt.-%]² | | | | |
| VZ F4 | 1.5 | 1.5 | 1.5 | 1.5 |
| Ettringite formation | | | | |
| controller [wt.-%]² | | | | |
| Time added | 30 | 30 | 30 | 30 |
| Accelerator after Mortar | | | | |
| mixing [min.] | | | | |
| Water [g] | 368.03 | 368.03 | 368.03 | 368.03 |
| (total amount) | | | | |

¹wt.-% of the sum of solid of active components relative to the weight of cement (bwoc)
²wt.-% of the sum of solid of active components relative to the weight of binder (cement plus anhydride)

TABLE 4

| | | | | | | | M7 | M8 | M9 | M10 |
|---|---|---|---|---|---|---|---|---|---|---|
| | M1 | M2 | M3 | M4 | M5 | M6 | (inv) | (inv.) | (inv.) | (inv.) |
| Vicat | 164 | 380 | +12¹ | +7¹ | +14¹ | +24¹ | +14¹ | +16¹ | +14¹ | +13¹ |
| needle | | | | | | | | | | |
| Begin | | | | | | | | | | |
| [min.] | | | | | | | | | | |
| Vicat | 272 | 440 | +17¹ | +14¹ | +23¹ | +30¹ | +18¹ | +20¹ | +18¹ | +16¹ |
| needle | | | | | | | | | | |
| End | | | | | | | | | | |
| [min.] | | | | | | | | | | |
| Strength | n.M. | n.M | n.M. | n.M. | n.M | n.M. | 4.1 | 3.3 | 2.7 | 5.0 |
| after 2 h | | | | | | | | | | |
| [N/mm²] | | | | | | | | | | |
| Strength | n.M. | n.M | n.M. | n.M. | n.M | n.M. | 6.45 | 7.1 | 7.1 | 8 |
| after 6 h | | | | | | | | | | |
| [N/mm²] | | | | | | | | | | |
| Strength | 15.0 | 1.67 | 6.75 | 17.8 | 2.2 | 2.4 | 6.95 | 8.81 | 8.5 | 9.4 |
| after 24 h | | | | | | | | | | |
| [N/mm²] | | | | | | | | | | |

| | M11 | M12 | M13 | | | | |
|---|---|---|---|---|---|---|---|
| | (inv.) | (inv.) | (inv.) | M14 | M15 | M16 | M17 |
| Vicat | +9¹ | +12¹ | +8¹ | +56¹ | +86¹ | +30¹ | +40¹ |
| needle | | | | | | | |
| Begin | | | | | | | |
| [min.] | | | | | | | |
| Vicat | +14¹ | +16¹ | +11¹ | +68¹ | +106¹ | +39¹ | +44¹ |
| needle | | | | | | | |
| End | | | | | | | |
| [min.] | | | | | | | |
| Strength | 3.2 | 4.1 | 5.9 | 4.6 | 0 | 4.7 | 4.5 |
| after 2 h | | | | | | | |
| [N/mm²] | | | | | | | |
| Strength | 5.1 | 6.6 | 8.9 | 6.7 | 6.7 | 6.3 | 6.8 |
| after 6 h | | | | | | | |
| [N/mm²] | | | | | | | |
| Strength | 7.7 | 7.7 | 10.2 | 9.5 | 9.1 | 9.1 | 9.2 |
| after 24 h | | | | | | | |
| [N/mm²] | | | | | | | |

n.M.: not measured, to weak
inv.: according to the invention
¹Setting time after accelerator is added

1.-15. (canceled)

16. A composition suitable to be applied to an object via a nozzle comprising, based on the total dry weight of the composition,
a) 15-90% by weight of a cementitious binder;
b) 0.02-3% by weight of an ettringite formation controller comprising
(i) a glyoxylic acid condensate and/or a glyoxylic acid adduct and/or glyoxylic acid;
c) 0.15-10% by weight of a magnesium salt accelerator;
d) 0.02-2% by weight of a polyhydroxy compound A and/or salts or esters thereof, wherein the polyhydroxy compound A is selected from polyalcohols with a carbon to oxygen ratio of C/O≥1 and mixtures thereof.

17. The composition according to claim 16, wherein the glyoxylic acid condensate is an amine-glyoxylic acid condensate, a melamine-glyoxylic acid condensate, a urea-glyoxylic acid condensate, a melamine-urea-glyoxylic acid condensate and/or a polyacrylamide-glyoxylic acid condensate and/or their salts.

18. The composition according to claim 16, wherein the glyoxylic acid adduct is a bisulfite adduct of glyoxylic acid or a salt or a mixed salt thereof, wherein the bisulfite adduct has the general formula (I) 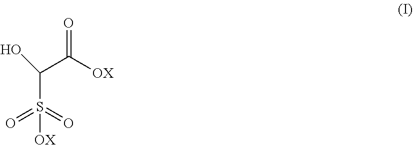
wherein X is in each case independently selected from H or a cation equivalent Kₐ, wherein K is an alkali metal, alkaline earth metal, zinc, iron, aluminum, ammonium, or a phosphonium cation, and wherein a is 1/n, wherein n is the valence of the cation.

19. The composition according to claim 16, wherein the ettringite formation controller additionally comprises (ii) a carbonate source.

20. The composition according to claim 19, wherein the inorganic carbonate is selected from sodium carbonate, lithium carbonate; and the organic carbonate is selected from ethylene carbonate and propylene carbonate.

21. The composition according to claim 16, wherein the ettringite formation controller additionally comprises (iii) a component selected from
polycarboxylic acids or salts thereof whose milliequivalent number of carboxyl groups is 5.00 meq/g or higher, assuming all the carboxyl groups to be in unneutralized form; and
α-hydroxy carboxylic acids or salts thereof.

22. The composition according to claim 16, wherein the cementitious binder is selected from Portland cement, gypsum, calcium aluminate cement and/or sulfoaluminate cement.

23. The composition according to claim 16, wherein the composition additionally comprises a latent hydraulic binder or a pozzolanic binder, or mixtures thereof.

24. The composition according to claim 16, wherein the polyhydroxy compound A is selected from sugar alcohols and their condensation products, alkanolamines and their condensation products, carbohydrates, pentaerythritol, trimethylolpropane, and mixtures thereof.

25. The composition according to claim 16, additionally comprising a dispersant, wherein the dispersant is selected from the group of
comb polymers having a carbon-containing backbone to which are attached pendant cement-anchoring groups and polyether side chains,
non-ionic comb polymers having a carbon-containing backbone to which are attached pendant hydrolysable groups and polyether side chains, the hydrolysable groups upon hydrolysis releasing cement-anchoring groups,
sulfonated melamine-formaldehyde condensates,
lignosulfonates,
sulfonated ketone-formaldehyde condensates,
sulfonated naphthalene-formaldehyde condensates,
phosphonate containing dispersants,
phosphate containing dispersants, and
mixtures thereof.

26. The composition according to claim 16, wherein the composition comprises less than 0.1% by weight of an alkali-free, aluminum-based accelerator based on the total dry weight of the composition.

27. The composition according claim 16, wherein the composition does not comprise an alkali-free, aluminum-based accelerator.

28. The composition according to claim 16, wherein the magnesium salt accelerator is selected from magnesium salts with a solubility of more than 100 g/liter at 20° C.

29. A process comprising
providing a composition comprising a) 15-90 by weight of a cementitious binder; b) 0.02 3% by weight of an ettringite formation controller comprising (i) a glyoxylic acid condensate and/or a glyoxylic acid adduct and/or glyoxylic acid; d) 0.02-2% by weight of a polyhydroxy compound A and/or salts or esters thereof, wherein the polyhydroxy compound A is selected from polyalcohols with a carbon to oxygen ratio of C/O≥1 and mixtures thereof,
admixing an c) 0.15-10% by weight of a magnesium salt accelerator; and
applying the composition onto a surface to obtain a structure and allowing the structure to harden;
wherein the % by weight are based on the total dry weight of the composition.

30. A hardened structure obtained by the process according to claim 29.
